(19) United States
(12) Patent Application Publication
(10) Pub. No.: US 2014/0244534 A1
(43) Pub. Date: Aug. 28, 2014

(54) CAREER DEVELOPMENT WORKFLOW

(71) Applicant: KORN FERRY INTERNATIONAL, Los Angeles, CA (US)

(72) Inventors: Andrew R. SIMMONS, Half Moon Bay, CA (US); Byrne K. MULROONEY, Charlotte, NC (US); Sean E. KENT, Sugar Hill, GA (US); Leslie J. PARSONS, London (GB)

(73) Assignee: Korn Ferry International, Los Angeles, CA (US)

(21) Appl. No.: 13/773,936

(22) Filed: Feb. 22, 2013

(51) Int. Cl. G06Q 10/10

(52) U.S. Cl. CPC G06Q 10/105; G06Q 50/2057
USPC 705/328

(57) ABSTRACT

Career development processes face three major challenges (1) simplifying steps that require input from multiple users, (2) promoting follow-through with career development plans, and (3) adapting to individual corporate business processes. These issues can be addressed by disabling access to a step if required previous steps have not yet been completed. Additionally, the user can receive a notification over a network when the required previous steps have been completed by a remote user. Follow-through with a career development plan can be promoted by dynamically altering a career development workflow to incorporate the steps of the development plan as they are created. That is, the development plan drives the definition of the career development workflow in which the user is already engaged, helping to monitor and enforce milestones of the development plan.

### FIELD OF THE DISCLOSURE

This relates generally to a graphical user interface for a career development workflow.

### BACKGROUND OF THE DISCLOSURE

Traditional career development techniques include assessing strengths and weaknesses, identifying goals, and formulating a development plan to reach the goals. Software systems have been developed to automate a subset of these processes, especially for assessments and performance management. However, software implementations of career development techniques have failed to simplify and streamline a single career development workflow.

### SUMMARY

Career development processes face three major challenges (1) simplifying steps that require input from multiple users, (2) promoting follow-through with career development plans, and (3) adapting to individual corporate business processes. Several steps in the process may require input from multiple users. For example, an employee assessment may need to be completed by both the employee and the employee's manager. Additionally, content created by the employee, such as a development plan, may need to be reviewed and approved by a manager. In some systems, a user may move on to a step before required previous steps have been completed by a different user. Additionally, a user may have no way of knowing when the required previous steps have actually been completed by the other user. Examples of the disclosure can address these issues by disabling access to a step if required previous steps have not yet been completed. Additionally, the user can receive a notification over a network when the required previous steps have been completed by a remote user.

Examples of the disclosure can also promote follow-through with a career development plan by dynamically altering a career development workflow to incorporate the steps of the development plan as they are created. That is, the development plan drives the definition of the career development workflow in which the user is already engaged, helping to monitor and enforce milestones of the development plan.

### BRIEF DESCRIPTION OF THE DRAWINGS

FIG. 1 illustrates an exemplary graphical user interface of a career development workflow according to examples of the disclosure.

FIG. 2 illustrates an exemplary card sort interface according to examples of the disclosure.

FIG. 3 illustrates an exemplary card select interface according to examples of the disclosure.

FIG. 4 illustrates an exemplary method of user interaction with a career development workflow according to examples of the disclosure.

FIG. 5 illustrates an exemplary method of user interaction with a career development workflow according to examples of the disclosure.

FIG. 6 illustrates an exemplary system for displaying a graphical user interface of a career development workflow according to examples of the disclosure.

### DETAILED DESCRIPTION

In the following description of embodiments, reference is made to the accompanying drawings which form a part hereof, and in which it is shown by way of illustration specific embodiments which can be practiced. It is to be understood that other embodiments can be used and structural changes can be made without departing from the scope of the disclosed embodiments.

Career development processes face three major challenges (1) simplifying steps that require input from multiple users, (2) promoting follow-through with career development plans, and (3) adapting to individual corporate business processes. Several steps in the process may require input from multiple users. For example, an employee assessment may need to be completed by both the employee and the employee's manager. Additionally, content created by the employee, such as a development plan, may need to be reviewed and approved by a manager. In some systems, a user may move on to a step before required previous steps have been completed by a different user. Additionally, a user may have no way of knowing when the required previous steps have actually been completed by the other user. Examples of the disclosure can address these issues by disabling access to a step if required previous steps have not yet been completed. Additionally, the user can receive a notification over a network when the required previous steps have been completed by a remote user. In some examples, a progress bar may be updated as steps are completed by a remote user.

Examples of the disclosure can also promote follow-through with a career development plan by dynamically altering a career development workflow to incorporate the steps of the development plan as they are created. That is, the development plan drives the definition of the career development workflow in which the user is already engaged, helping to monitor and enforce milestones of the development plan.

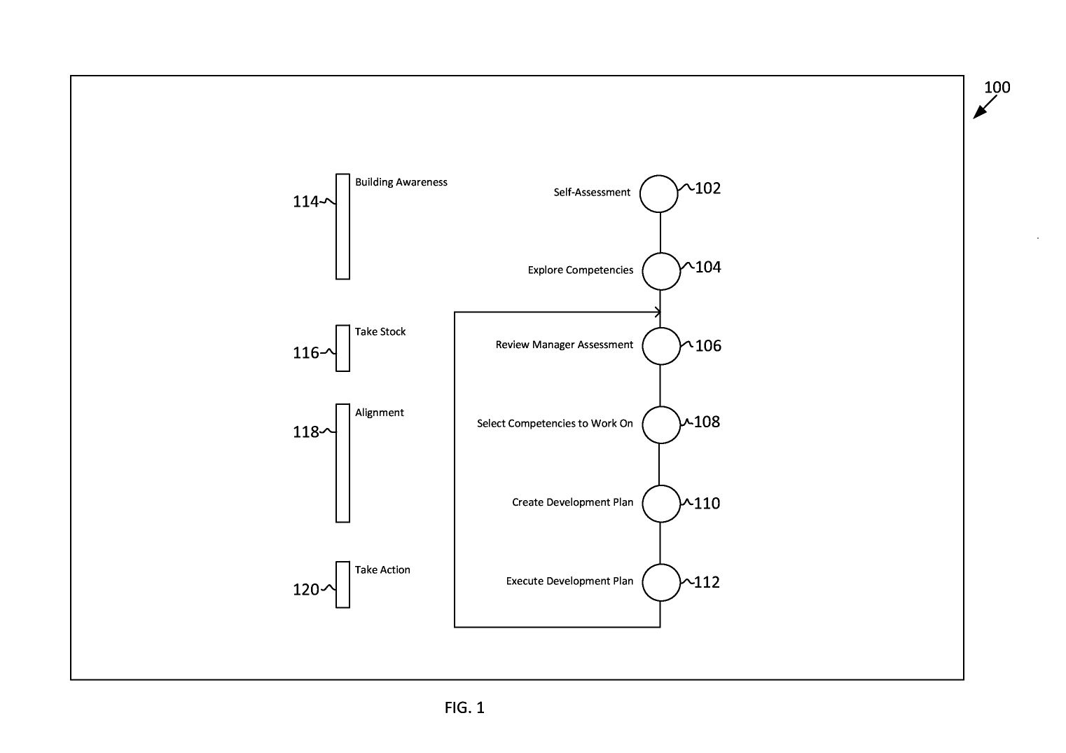

FIG. 1 illustrates an exemplary graphical user interface of a career development workflow according to examples of the disclosure. A career development workflow 100 can include a plurality of steps presented in a sequence. For example, steps can include a self-assessment 102, exploring competencies 104, reviewing a manager's assessment 106, choosing competencies to work on 108, creating a development plan 110, and executing the development plan 112.

Additionally, each step in the workflow can be associated with a phase of the workflow. For example, the first two steps 102 and 104 can be associated with a phase “Building. Awareness” 114, the third step 106 can be associated with a phase “Take Stock” 116, the fourth step 108 and fifth step 110 can be associated with a phase “Alignment” 118, and the final step 112 can be associated with a phase “Take Action” 120. FIG. 1 illustrates each workflow step displayed in alignment with its associated phase to indicate the association. Additionally, where several workflow steps are associated with the same phase, an indication of the phase may only be displayed once, and each associated workflow step may be displayed aligned with the single indication of the phase, as illustrated in FIG. 1.

User input can be accepted on a user interface object to activate content and/or actions associated with a step. For example, user input can be accepted on any of the user interface objects 102-112 in FIG. 1. A step may be associated with entry content, one or more actions, and exit content. In response to user input on a step, associated entry content may be displayed. Content can include any digital media (e.g., text, graphics, images, audio, or video) that provides instructions, insights, and illustrative vignettes.

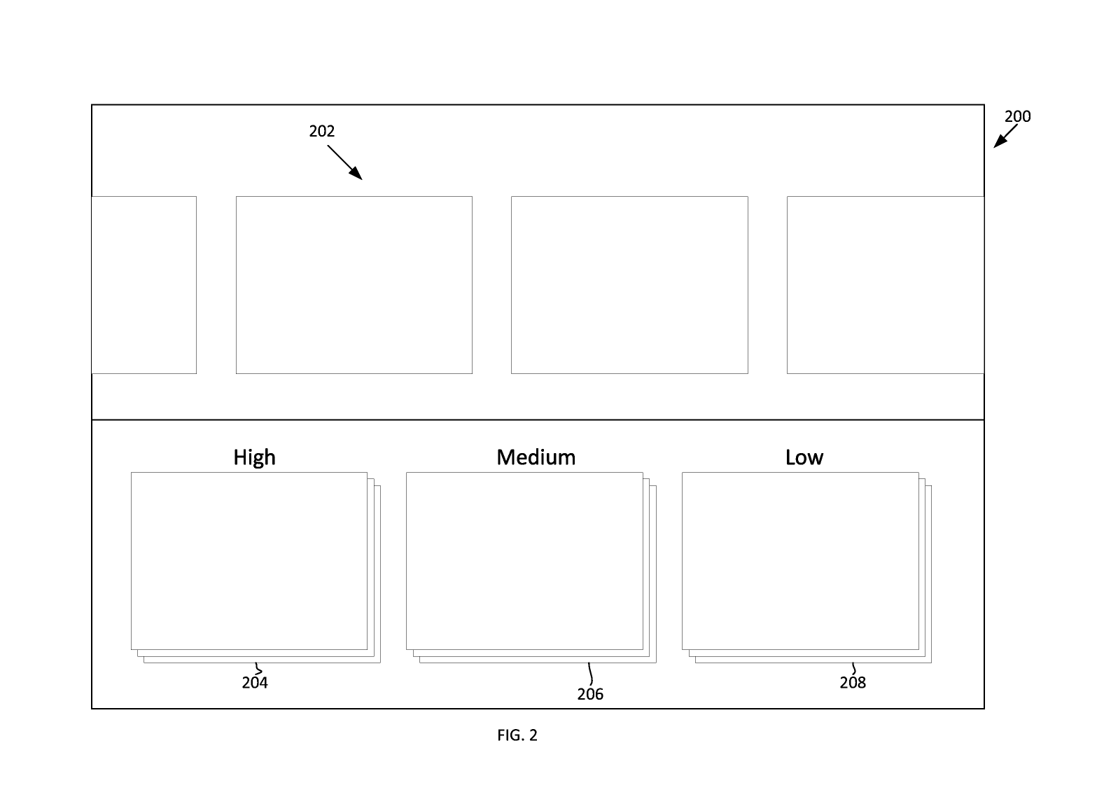

After displaying the entry content, one or more actions may be activated. Actions may include an interactive activity that the user must complete. For example, the user may be presented with a survey or questionnaire for completion. In some examples, a series of cards may be displayed and the user may be requested to sort the cards into a plurality of categories. Each card may be associated with a competency, and by sorting the cards into categories the user can indicate his or her relative skill level at that competency. Such an action can provide an assessment of the user's experience and skill in relation to various competencies. An exemplary card sort interface is described below with reference to FIG. 2.

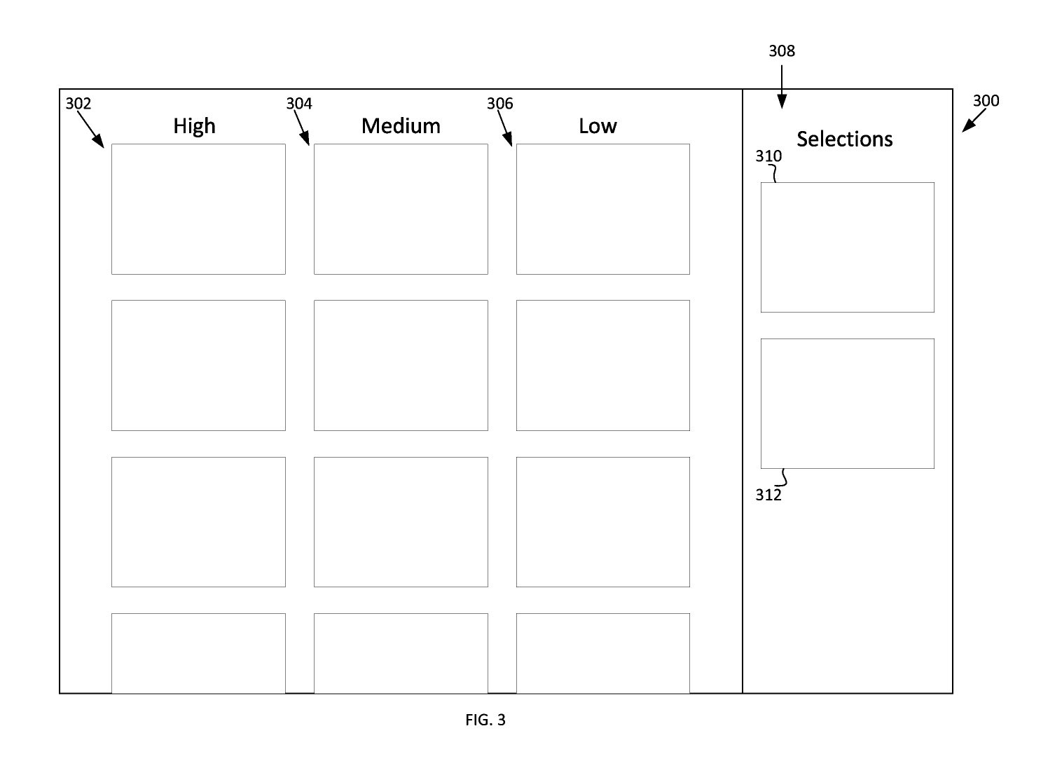

In other examples, a series of cards may be displayed and the user may select a limited number of the cards. Again each card may be associated with a competency, and by selecting cards the user may indicate which competencies to focus on for improvement as part of a development plan. An exemplary card select interface is described below with reference to FIG. 3.

Once an action is complete, exit content may be displayed before again displaying the career development workflow depiction. As actions associated with steps are completed, a user interface object associated with the step may indicate that the step is complete. For example, the user interface object may change color, an image may be displayed indicating that the step is complete, and/or a dialog box may be displayed indicating the step is complete.

The steps in the workflow may change based on one or more actions completed by a user at a given step. For example, as a user completes an action associated with step 110 for creating a development plan, one or more steps associated with the created development plan may be added to the workflow and placed in the sequence following step 110. When a competency (e.g., career goal) is selected, a step may be added automatically to the workflow in the sequence following step 110, thus creating a step in the development plan to address that goal. Additionally, a phase such as “Take Action” 120 may be associated with the step. Milestones defined within the development plan may be placed automatically as additional steps in the workflow. User input may be accepted on the newly created steps, and a plan can be created and milestones updated in response to the user input.

In another example, one or more development plan creation steps may be added to the workflow as a user selects competencies in an action associated with step 108 (e.g., the card select interface described below with reference to FIG. 3). A development plan creation step associated with each selected competency may be added to the workflow.

Additionally, some steps in the workflow may be associated with a certain user role. For example, some steps may be associated with an employee role and other steps may be associated with a manager role. The steps may only be completed by a user with the associated user role. Additionally, a user in an employee role may only be able to view steps associated with that role, and other steps may be hidden from the user interface. In some examples, each step may be displayed with a graphical indication of an associated user and/or user role. A user with a manager role may be able to view the workflow of another user, such as an employee workflow. Additionally, a user with the manager role may be able to view a progress bar indicating the progress of an employee in completing one or more steps of the employee workflow.

In some examples, a disabled step may only be activated if a previous step has already been completed. In such a case, the disabled step may not respond to user input, or in response to user input a message may be displayed indicating that a previous step must be first completed before the step may be activated. If the previous step is associated with a different user, the current user may be notified in the graphical user interface when the different user completes the previous step, and the user interface object associated with the disabled step may change its appearance to indicate that it is now enabled and may be activated. In some examples, the user interface may display a progress bar associated with one or more steps of a different user's workflow. When the different user completes a step, the progress bar may be updated to show that a new step has been completed.

FIG. 2 illustrates an exemplary card sort interface 200 according to examples of the disclosure. One or more cards 202 can be displayed, each card associated with a particular competency. Additionally, card stacks 204, 206, and 208 can be associated with a high, medium, and low skill level, respectively. User input can be accepted on the one or more cards 202 to scroll through the cards, and further to drag a card to one of the card stacks 204, 206, and 208. By dragging a card to one of the stacks, a user may indicate that a competency associated with the card is at a skill level associated with the card stack. For example, a first card may be associated with a competency of “Creativity.” By dragging the “Creativity” card to a medium skill level stack, the user can indicate that he or she has a medium skill level for “Creativity.” By sorting all the cards into the respective stacks, a user can provide a skill assessment of the various competencies associated with the cards. Although three skill level stacks are illustrated in FIG. 2, various examples may have any number of skill level stacks.

FIG. 3 illustrates an exemplary card select interface 300 according to examples of the disclosure. Three sets of cards 302, 304, and 306 may be displayed, each set associated with a high, medium, or low skill level, respectively. The sets may represent competency cards previously sorted into those three skill levels, as discussed with reference to FIG. 2. User input may be accepted on the cards to scroll through each set of cards, and further to drag a card into a region of the display 308 associated with card “Selections.” That is, the user may indicate that competencies associated with the cards 310 and 312 that have been dragged to the “Selections” region 308 should be developed as part of the development plan. Although only three skill level sets are displayed in FIG. 3, various examples may have any number of skill level sets. Additionally, although only two cards 310 and 312 are displayed in the “Selections” region 308 in FIG. 3, various examples may allow a user to drag any number of cards to the region 308. Some examples may explicitly limit the number and/or type of cards in the region 308. In some examples, when a user selects a competency by dragging a card associated with that competency to the “Selections” region 308, a development plan creation step associated with the competency may be added to the workflow.

Additionally, each card and/or competency may be assigned a priority and the order of display in each set may be based on the priorities of the cards. In some examples, the selection of a card may be denied based on the priority associated with the card and/or the priorities of cards already selected. For example, if the priority indicates a difficulty of developing a competency associated with the card, the selection of a high difficulty competency may be denied based on the priority.

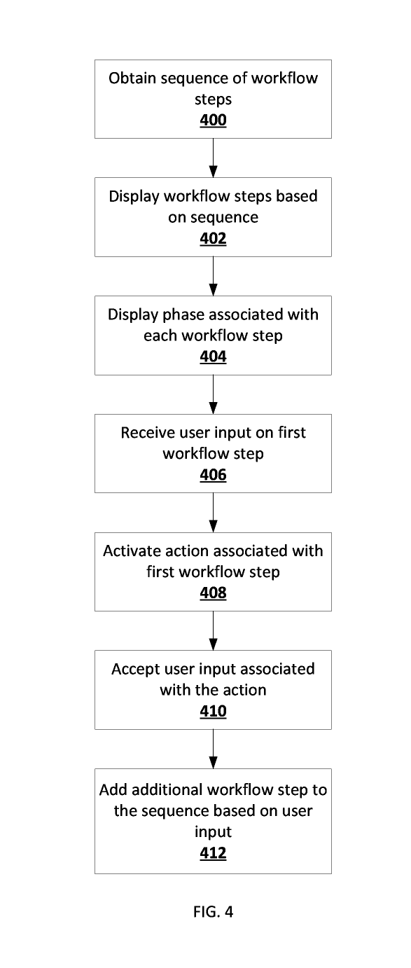

FIG. 4 illustrates an exemplary method of user interaction with a career development workflow according to examples of the disclosure. A sequence of workflow steps may be obtained (400). The sequence may be provided in a workflow definition, either stored locally or obtained over a network from a remote device, such as a server or a remote user. The workflow steps may be displayed in a configuration based on the sequence (402), such as illustrated in FIG. 1. For example, the steps may be displayed in an order based on the sequence. In some examples, arrows and/or lines may be displayed from one step to the next based on the sequence. Each of the workflow steps may be associated with a phase, and the phase associated with each workflow step may be displayed (404). If a phase is associated with more than one workflow step, a single indication of the phase may be displayed and each of the associated workflow steps may be displayed in association with the single phase indication. For example, the associated workflow steps may be displayed aligned with the indication of the phase as illustrated in FIG. 1.

User input may be received on a first workflow step (406). User input may be received via an input device such as a keyboard, mouse, touch pad, or touch screen, among other possibilities. In response to the user input, an action associated with the first workflow step may be activated (408). As discussed above, activating an action may include an interactive activity for completion by the user, which may include accepting user input associated with the action (410). For example, user input may be accepted to sort competency cards into skill level stacks, as discussed with reference to FIG. 2. Additionally, user input may be accepted to select competency cards for development, as discussed with reference to FIG. 3. An additional workflow step may be added to the sequence based on the user input associated with the action (412). For example, if the action includes creating a development plan, one or more steps associated with the development plan may be added to the workflow sequence.

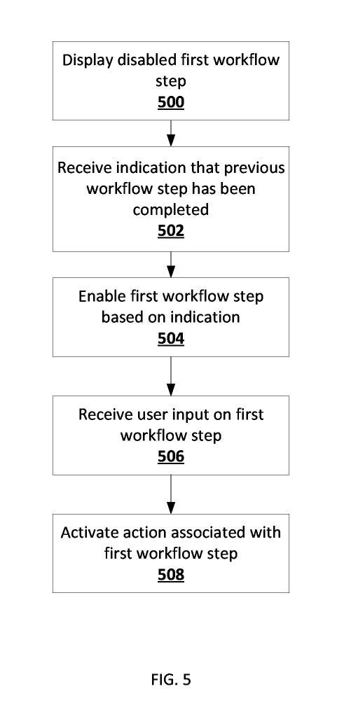

FIG. 5 illustrates an exemplary method of user interaction with a career development workflow according to examples of the disclosure. As discussed above, a workflow step may be disabled because it depends on the completion of a previous step in the workflow. The disabled first workflow step may be displayed (500). This may include displaying an indication that the first workflow step may not yet be activated. An indication that the previous workflow step has been completed may be received (502). In some cases, the previous workflow step may be completed by one or more remote users, and the indication may be received over a network. The first workflow step may be enabled based on the indication that the previous workflow step has been completed (504). This may include displaying an indication that the first workflow step may now be activated. For example, the user may receive a notification that the first workflow step may now be activated. User input may be received on the first workflow step (506), and an action associated with the first workflow step may be activated (508).

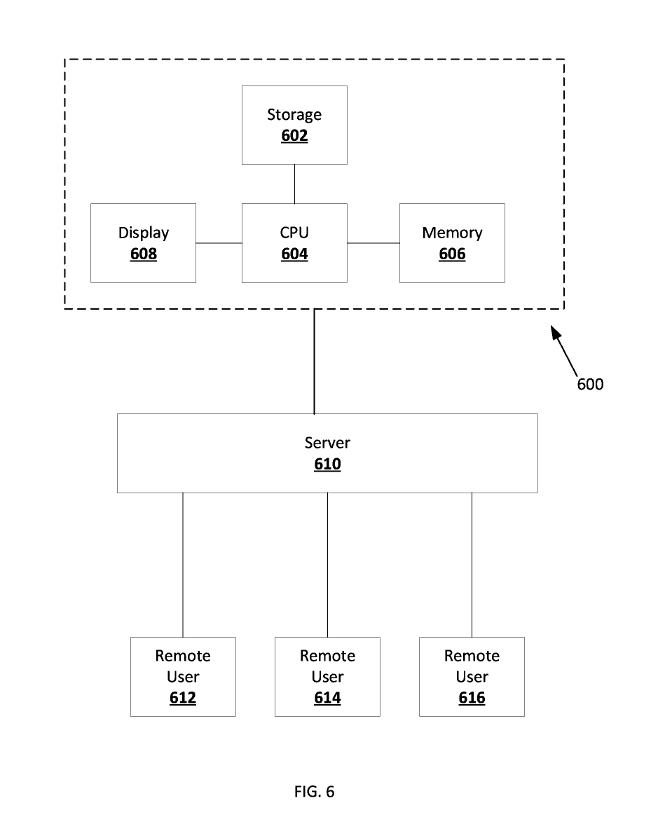

FIG. 6 illustrates an exemplary system 600 for displaying a graphical user interface of a career development workflow according to examples of the disclosure. The system 600 can include a CPU 604, storage 602, memory 606, and display 608. The CPU 604 can perform the methods illustrated in and described with reference to FIGS. 1-5. Additionally, the storage 602 can store instructions for performing the methods illustrated and described with reference to FIGS. 1-5. The storage can be any non-transitory computer-readable storage medium, such as a solid-state drive or a hard disk drive, among other possibilities. A graphical user interface as described in various examples may be displayed on the display 608.

The system 600 can communicate with server 610 and one or more remote users 612, 614, and 616 over a wired or wireless network, such as a local area network, wide-area network, or internet, among other possibilities. In some examples, the system 600 may receive a workflow definition from the server 610 or a remote user 612, 614, or 616. Additionally, one or more steps in a workflow may be completed by one or more remote users 612, 614, and/or 616, and an indication that a step has been completed may be transmitted from a remote user to the system 600 and/or through the server 610. Only three remote users are illustrated in FIG. 6, but any number of remote users may interact with the server 610 and the system 600. Additionally, remote users as illustrated in FIG. 6 may be systems similar to system 600.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

1. A computer-implemented method, comprising:
at an electronic device including one or more processors:
obtaining a sequence of workflow steps, each step associated with a phase;
displaying the workflow steps in a configuration based on the sequence;
displaying the phase associated with each workflow step;
receiving user input on a first workflow step;
in response to the user input, activating an action associated with the first workflow step, wherein activating the action includes displaying a card interface;
receiving user input interacting with one or more cards of the card interface; and
displaying updated workflow steps, including one or more of the sequence of workflow steps and one or more new workflow steps generated based on the user input interacting with the one or more cards of the card interface.

2. The method of claim 1, wherein activating the action includes accepting user input associated with the action, the method further comprising:
adding an additional workflow step to the sequence based on the user input associated with the action.

3. The method of claim 2, wherein the first workflow step includes creating a development plan, and the additional workflow step is a step in the created development plan.

4. The method of claim 1, further comprising:
receiving an indication that a previous workflow step has been completed by one or more remote users; and
enabling the first workflow step based on the indication that the previous workflow step has been completed by the one or more remote users.

5. The method of claim 4, wherein receiving the indication includes receiving a notification that the previous workflow step has been completed.

6. The method of claim 4, wherein enabling the first workflow step includes displaying a user interface object indicating that the first workflow step has been enabled.

7. A non-transitory computer readable storage medium having stored therein instructions, which when executed by a device, cause the device to perform a method comprising:
obtaining a sequence of workflow steps, each step associated a phase;
displaying the workflow steps in a configuration based on the sequence;
displaying the phase associated with each workflow step;
receiving user input on a first workflow step;
in response to the user input, activating an action associated with the first workflow step, wherein activating the action includes displaying a card interface;
receiving user input interacting with one or more cards of the card interface; and
displaying updated workflow steps, including one or more of the sequence of workflow steps and one or more new workflow steps generated based on the user input interacting with the one or more cards of the card interface.

8. The non-transitory computer readable storage medium of claim 7, wherein activating the action includes accepting user input associated with the action, the method further comprising:
adding an additional workflow step to the sequence based on the user input associated with the action.

9. The non-transitory computer readable storage medium of claim 8, wherein the first workflow step includes creating a development plan, and the additional workflow step is a step in the created development plan.

10. The non-transitory computer readable storage medium of claim 7, the method further comprising:
receiving an indication that a previous workflow step has been completed by one or more remote users; and
enabling the first workflow step based on the indication that the previous workflow step has been completed by the one or more remote users.

11. The non-transitory computer readable storage medium of claim 10, wherein receiving the indication includes receiving a notification that the previous workflow step has been completed.

12. The non-transitory computer readable storage medium of claim 10, wherein enabling the first workflow step includes displaying a user interface object indicating that the first workflow step has been enabled.
